(19) United States
(12) Patent Application Publication
(10) Pub. No.: US 2023/0024797 A1
(43) Pub. Date: Jan. 26, 2023

(54) CONTENT SELECTION DEVICE, CONTENT DISPLAY SYSTEM, AND CONTENT SELECTION METHOD

(71) Applicant: Sharp NEC Display Solutions Ltd., Tokyo (JP)

(72) Inventor: Masaya SUMITANI, Tokyo (JP)

(21) Appl. No.: 17/960,402

(22) Filed: Oct. 5, 2022

Related U.S. Application Data
(63) Continuation of application No. PCT/JP2021/017076, filed on Apr. 28, 2021.

(30) Foreign Application Priority Data
Apr. 30, 2020 (JP) PCT/JP2020/018322

(51) Int. Cl. G06T 7/70; G06T 7/20; G06V 40/10; G06F 3/14

(52) U.S. Cl. CPC G06T 7/70; G06T 7/20; G06V 40/103; G06F 3/14; G06V 2201/07; G06T 2207/30196

(57) ABSTRACT

A content selection device includes: an image acquisition unit configured to acquire an image captured by an image capture device configured to capture a person; a human detection unit configured to detect one or more persons included in the image; and a selection unit configured to select a first person who has a slower moving speed than at least one other person from among the one or more persons, and select a first content according to an attribute of the first person as a content to be displayed on a display device.

### TECHNICAL FIELD

The present disclosure relates to a content selection device, a content display system, and a content selection method.

The present application is a Continuation of PCT International Application No. PCT/JP2021/017076 filed on Apr. 28, 2021, which claims priority of PCT International Application No. PCT/JP2020/018322 filed on Apr. 30, 2020. The entire contents of all of the above applications are hereby incorporated by reference into the present application.

### BACKGROUND ART

Conventionally, various techniques for controlling display of contents in display devices, such as digital signage, have been proposed.

For example, Patent Document 1 discloses a technique for displaying on a display device, an advertisement according to a movement of a pedestrian. In this technique, for example, an advertisement having contents according to a walking speed and an attribute of a pedestrian is displayed on the display device.

### CITATION LIST

### Patent Document

Patent Document 1: Japanese Patent Application Laid-Open Publication No. 2017-123120

### SUMMARY

However, in the technique of Patent Document 1, since the advertisement is displayed even for a pedestrian with a high walking speed, the advertisement is hard to be noticed by the pedestrian. For example, it is assumed that an advertisement matching attributes of pedestrians with high walking speeds are being displayed on the display device. The pedestrians with the high walking speeds may not see the displayed advertisement because they are in a hurry. Also, pedestrians with slow walking speeds may not see the displayed advertisement because the displayed advertisement does not match their attributes.

In view of the above problems, an object of the present disclosure is to provide a content selection device, a content display system, a content selection method, and a storage medium capable of making the content displayed on the display device easily noticeable to pedestrians.

In order to solve the above-mentioned problems, a content selection device according to one aspect of the present disclosure includes: an image acquisition unit configured to acquire an image captured by an image capture device configured to capture a person; a human detection unit configured to detect one or more persons included in the image; and a selection unit configured to select a first person who has a slower moving speed than at least one other person from among the one or more persons, and select a first content according to an attribute of the first person as a content to be displayed on a display device.

A content selection method according to one aspect of the present disclosure includes: acquiring an image captured by an image capture device configured to capture a person; detecting one or more persons included in the image; selecting a first person who has a slower moving speed than at least one other person from among the one or more persons; and selecting a first content according to an attribute of the first person as a content to be displayed on a display device.

A content selection device according to one aspect of the present disclosure includes: an image acquisition unit configured to acquire an image captured by an image capture device configured to capture a person; a human detection unit configured to detect one or more persons included in the image; and a selection unit configured to select, as a content to be displayed after an end of a playback of a first content displayed on a display device, a second content according to an attribute of a first person who is close to the display device at the end of the playback of the first content, among the one or more persons.

According to the present disclosure, the content displayed on the display device can be easily noticed by pedestrians.

### BRIEF DESCRIPTION OF THE DRAWINGS

FIG. 1 is a diagram showing an example of a configuration of a content display system according to each embodiment.

FIG. 2 is a block diagram showing an example of a functional configuration of a content selection device according to a first embodiment.

FIG. 3 is a block diagram showing an example of a functional configuration of a content management device according to the first embodiment.

FIG. 4 is a flowchart showing an example of a processing flow in the content display system according to the first embodiment.

FIG. 5 is a block diagram showing an example of a functional configuration of a content selection device according to a second embodiment.

FIG. 6 is a diagram showing an example of a content selection process according to the second embodiment.

FIG. 7 is a flowchart showing an example of a processing flow in the content display system according to the second embodiment.

FIG. 8 is a block diagram showing an example of a functional configuration of a content selection device according to a third embodiment.

FIG. 9 is a diagram showing an example of a content selection process according to the third embodiment.

FIG. 10 is a flowchart showing an example of a processing flow in the content display system according to the third embodiment.

FIG. 11 is a block diagram showing an example of a functional configuration of a content selection device according to a fourth embodiment.

### DETAILED DESCRIPTION

Hereinafter, each embodiment of the present disclosure will be described in detail with reference to the drawings. The drawings show, as needed, an X-axis, a Y-axis, and a Z-axis which are orthogonal to one another. The X-axis, Y-axis, and Z-axis are common to all drawings. In each axis, a direction in which an arrow extends is referred to as “positive direction,” and a direction opposite to the positive direction is referred to as “negative direction.”

### 1. First Embodiment

First, the first embodiment of the present disclosure will be described.

### <1-1. Configuration of Content Display System>

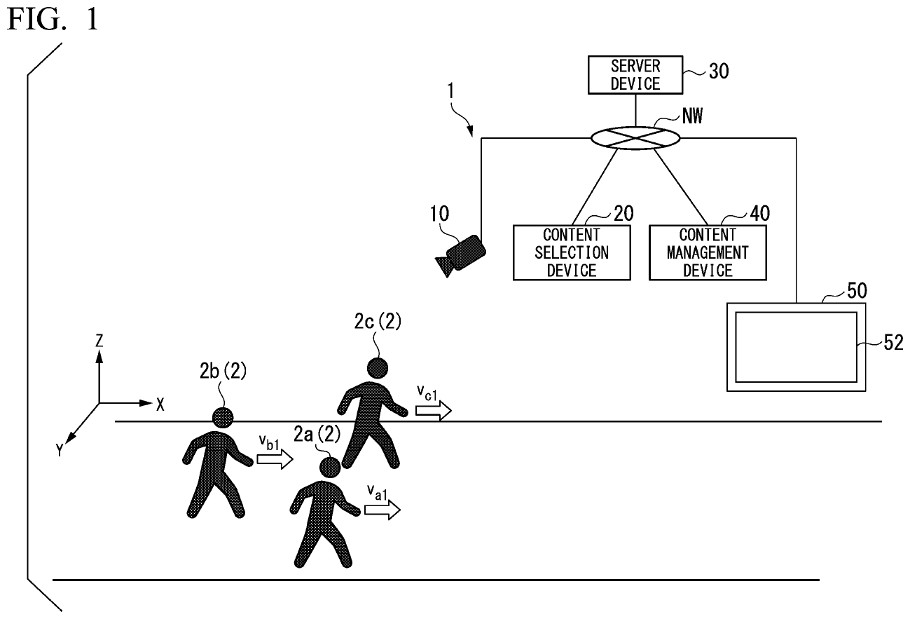

An example of a configuration of a content display system according to the first embodiment will be described with reference to FIG. 1. FIG. 1 is a diagram showing an example of a configuration of a content display system according to each embodiment. As shown in FIG. 1, a content display system 1 includes an image capture device 10, a content selection device 20, a server device 30, a content management device 40, and a display device 50.

Each device of the content display system 1 is connected so as to be able to transmit and receive information to and from each other via a network NW.

For example, the content selection device 20 and the server device 30, and the server device 30 and the content management device 40 are connected via a wide area network (WAN). The WAN is realized, for example, by the Internet connection.

Further, for example, the image capture device 10 and the content selection device 20, the content selection device 20 and the content management device 40, and the content management device 40 and the display device 50, are connected via a local area network (LAN). The LAN may be realized by a wired connection, or may be realized by a wireless connection such as Bluetooth (registered trademark) or Wi-Fi (registered trademark).

Here, the image capture device 10 is an example of an “image capture unit” of the content display system 1. The display device 50 is an example of a “display unit” of the content display system 1.

### (1) Image Capture Device 10

The image capture device 10 is a device that acquires an image by capturing an image of a person (hereinafter, also referred to as “captured image”). The image capture device 10 is, for example, a camera. The image capture device 10 transmits the captured image to the content selection device 20 via the network NW.

A person in the first embodiment is, for example, a person with an arbitrary movement speed. The person may be a walking person (pedestrian), a running person, or a standing person (that is, a person whose moving speed is 0) depending on the moving speed. Hereinafter, in the first embodiment, an example in which the person is a pedestrian 2 (2a, 2b, 2c) and the moving speed is a walking speed of the pedestrian 2 will be described. Here, the person may be a person riding a mobile object (for example, an automobile, a bicycle, or the like). Further, the number of pedestrians captured by the image capture device 10 is not limited to the three pedestrians 2a to 2c. The image capture device 10 may capture an image of an arbitrary number of pedestrians.

The pedestrian 2 is a person who walks in an arbitrary direction and at an arbitrary speed. For example, as shown in FIG. 1, the pedestrian 2a is walking in the positive direction of the X-axis at a walking speed Vₐ₁. The pedestrian 2b is walking in the positive direction of the X-axis at a walking speed V_{b1}. The pedestrian 2c is walking in the positive direction of the X-axis at a walking speed V_{c1}.

### (2) Content Selection Device 20

The content selection device 20 is a terminal that selects a content to be displayed on the display device 50. For example, the content selection device 20 selects a content to be displayed on the display device 50, based on the captured image received from the image capture device 10. The content selection device 20 transmits a content selection result to the content management device 40 via the network NW. Here, the content is, for example, an image (still image/moving image) showing an advertisement. In addition, the process performed by the content selection device 20 may be performed by the server device 30.

In the present embodiment, attributes of a person are associated with a content as a selection condition for selecting the content. The attributes of a person are information that indicates characteristics of the person. Examples of the attributes of a person include gender, age group, profession, clothing, belongings, and the like. A content is associated with at least one attribute of a person. The content selection device 20 detects an attribute of a person based on the captured image, and selects a content associated with the detected attribute as the selection condition, as the content to be displayed on the display device 50. Here, when a plurality of attributes of a person are detected, the content selection device 20 selects a content associated with at least one of the plurality of detected attributes as the selection condition, as the content to be displayed on the display device 50. Hereinafter, information in which an attribute of a person and a content are associated with each other is also referred to as “association information.”

### (3) Server Device 30

The server device 30 is a device that performs processing related to various conditions and contents.

For example, the server device 30 generates information such as various conditions, attributes of a person, and association information, which are used in the content selection device 20. The server device 30 transmits the generated information to the content selection device 20 and causes the content selection device 20 to store the generated information. The server device 30 may update the information stored in the content selection device 20.

Various conditions include, for example, selection conditions, priority conditions, and selection conditions.

The selection condition is a condition for specifying which of a plurality of priority conditions is to be used.

The priority condition is a condition for selecting which of a plurality of contents is to be preferentially displayed on the display device 50. The priority condition defines, for example, an attribute (selection condition) for preferentially selecting a content.

Further, for example, the server device 30 generates a content to be managed by the content management device 40. The server device 30 transmits the generated content to the content management device 40 and causes the content management device 40 to store the generated content. The server device 30 may update the contents stored in the content management device 40.

### (4) Content Management Device 40

The content management device 40 is a device that manages the contents to be displayed on the display device 50. For example, the content management device 40 stores the contents received from the server device 30. Further, for example, the content management device 40 plays back a content to be displayed on the display device 50, based on the selection result received from the content selection device 20. The content management device 40 transmits to the display device 50, a video signal of the content being played back. Here, the processing performed by the content management device 40 may be performed by the server device 30.

### (5) Display Device 50

The display device 50 is a device that displays a content on a display screen 52 based on the video signal received from the content management device 40. The display device 50 is, for example, digital signage, and displays a content indicating an advertisement. The display screen 52 is, for example, a liquid crystal display, a plasma display, an organic EL (Organic Electro-Luminescence) display, or the like. Further, the digital signage may be realized by a device that displays a content by projecting the content from a projector onto the screen.

### <1-2. Functional Configuration of Content Selection Device>

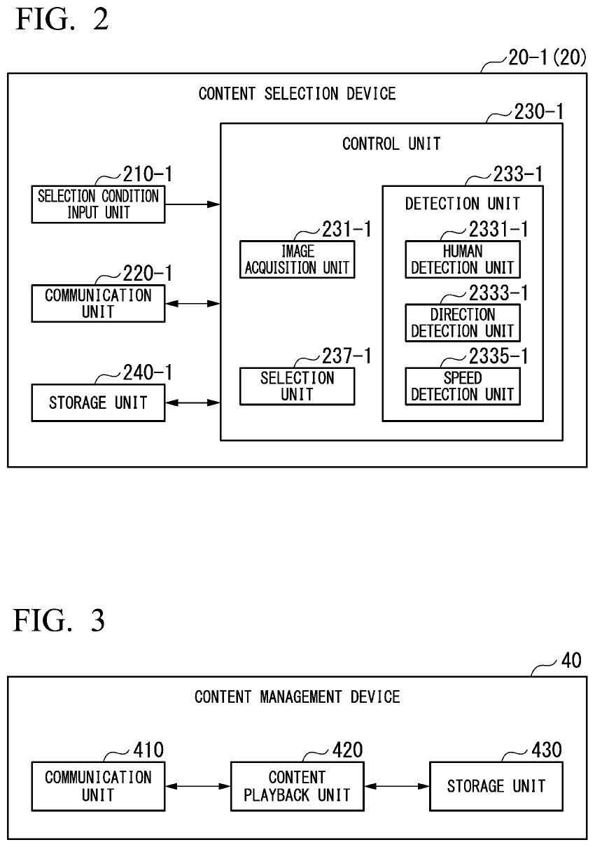

The example of the configuration of the content display system 1 according to the first embodiment has been described above. Subsequently, with reference to FIG. 2, an example of a functional configuration of the content selection device according to the first embodiment will be described. FIG. 2 is a block diagram showing an example of a functional configuration of the content selection device according to the first embodiment. As shown in FIG. 2, a content selection device 20-1 includes a selection condition input unit 210-1, a communication unit 220-1, a control unit 230-1, and a storage unit 240-1.

### (1) Selection Condition Input Unit 210-1

The selection condition input unit 210-1 specifies which of a plurality of priority conditions is to be used, based on a selection condition inputted by a user (for example, a system administrator).

The selection condition is inputted by, for example, an operation by the user of an input device such as a keyboard, a mouse, and a microphone (hereinafter, also referred to as “microphone”). The selection condition input unit 210-1 specifies that the priority condition of the plurality of priority conditions, which is indicated by the selection condition inputted by the user, is used for content selection.

For example, when the user inputs a selection condition that a priority condition is directly specified, the selection condition input unit 210-1 specifies that the priority condition directly specified by the user is used for content selection. Further, when the user inputs a plurality of selection conditions, the selection condition input unit 210-1 may specify, based on a combination of the selection conditions, a priority condition to be used for content selection.

After specifying the priority condition, the selection condition input unit 210-1 outputs to the control unit 230-1, information indicating the specified priority condition to be used for content selection.

### (2) Communication Unit 220-1

The communication unit 220-1 transmits and receives various information. For example, the communication unit 220-1 transmits a control signal to the image capture device 10 and receives a captured image from the image capture device 10. The communication unit 220-1 outputs the received captured image to the control unit 230-1. Further, the communication unit 220-1 transmits to the display device 50, the content received from the control unit 230-1.

### (3) Control Unit 230-1

The control unit 230-1 controls an entire operation of the content selection device 20-1. The control unit 230-1 is realized by causing a CPU (Central Processing Unit) provided as hardware in the content selection device 20-1 to execute a program. As shown in FIG. 2, the control unit 230-1 includes an image acquisition unit 231-1, a detection unit 233-1, and a selection unit 237-1.

### (3-1) Image Acquisition Unit 231-1

The image acquisition unit 231-1 acquires an image captured by the image capture device 10. For example, the image acquisition unit 231-1 acquires a captured image transmitted from the image capture device 10 via the network NW. The image acquisition unit 231-1 outputs the acquired captured image to the detection unit 233-1.

### (3-2) Detection Unit 233-1

The detection unit 233-1 performs various detection processes. As shown in FIG. 2, the detection unit 233-1 includes a human detection unit 2331-1, a direction detection unit 2333-1, and a speed detection unit 2335-1.

### (3-2-1) Human Detection Unit 2331-1

The human detection unit 2331-1 detects a person included in the captured image. For example, the human detection unit 2331-1 detects a person included in the captured image by an image recognition process for the captured image received from the image acquisition unit 231-1. Here, the number of persons detected by the person detection unit 2331-1 is not particularly limited, and may be one or more. When a person is detected, the human detection unit 2331-1 further detects an attribute of the detected person by an image recognition process for the detected person.

The process by which the human detection unit 2331-1 detects a person and an attribute from a captured image is also referred to as a “human detection process” below.

When a person is detected by the human detection process, the human detection unit 2331-1 outputs the detection result to the direction detection unit 2333-1 and the selection unit 237-1. On the other hand, when no person is detected by the human detection process, the human detection unit 2331-1 outputs the detection result to the selection unit 237-1.

### (3-2-2) Direction Detection Unit 2333-1

The direction detection unit 2333-1 detects a direction of the person included in the captured image. For example, the direction detection unit 2333-1 detects a movement direction of the person detected by the human detection unit 2331-1 by an image recognition process for the captured image received from the image acquisition unit 231-1. When a movement direction of the person is detected, the direction detection unit 2333-1 further detects a person whose movement direction corresponds to the direction of the display device 50. Further, the direction detection unit 2333-1 may detect a face direction of the person detected by the human detection unit 2331-1 by the image recognition process for the captured image received from the image acquisition unit 231-1. When a face direction of the person is detected, the direction detection unit 2333-1 further detects a person whose face direction corresponds to the direction of the display device 50.

The processes by which the direction detection unit 2333-1 detects from the captured image, a person whose movement direction corresponds to the direction of the display device 50 and a person whose face direction corresponds to the direction of the display device 50 are also referred to as “direction detection process.”

Here, an example where the detected movement direction corresponds to the direction of the display device 50 is shown. For example, when the display device 50 is included in a visual field of the person, the detected movement direction is the direction corresponding to the direction of the display device 50. Further, for example, when the movement direction is toward the display device 50, the detected movement direction is the direction corresponding to the direction of the display device 50.

Further, an example where the detected face direction of the person corresponds to the direction of the display device 50 is shown. For example, when the display device 50 is included in a visual field of the person based on the face direction of the detected person, the detected face direction of the person is the direction corresponding to the direction of the display device 50. Further, when the detected face direction of the person is toward the direction of the display device 50, the detected face direction of the person is the direction corresponding to the direction of the display device 50.

When a person whose movement direction or face direction corresponds to the direction of the display device 50 is detected by the direction detection process, the direction detection unit 2333-1 outputs the detection result to the speed detection unit 2335-1 and the selection unit 237-1. On the other hand, when no person whose movement direction or face direction corresponds to the direction of the display device 50 is detected, the direction detection unit 2333-1 outputs the detection result to the selection unit 237-1. Here, the detection result outputted by the direction detection unit 2333-1 to each unit may include the result of the detection by the human detection unit 2331-1.

### (3-2-3) Speed Detection Unit 2335-1

The speed detection unit 2335-1 detects a moving speed of a person included in the captured image. For example, the speed detection unit 2335-1 detects a walking speed of the pedestrian detected by the human detection unit 2331-1, by the image recognition process for the captured image received from the image acquisition unit 231-1. Here, the speed detection unit 2335-1 may detect only a walking speed of the pedestrian whose face direction corresponds to the direction of the display device 50, which is detected by the direction detection unit 2333-1. The speed detection unit 2335-1 outputs the detection result to the selection unit 237-1. Here, the detection result outputted from the speed detection unit 2335-1 to the selection unit 237-1 may include the results of the detections by the human detection unit 2331-1 and the direction detection unit 2333-1.

The process by which the speed detection unit 2335-1 detects the moving speed of the person from the captured image is also referred to as “speed detection process” below.

### (3-3) Selection Unit 237-1

The selection unit 237-1 performs a process of selecting a content to be displayed on the display device 50 according to an attribute of the detected person (hereinafter, also referred to as “content selection process”). The selection unit 237-1 causes the communication unit 220-1 to transmit the selection result to the content management device 40.

For example, the selection unit 237-1 selects, based on the detection result received from the detection unit 233-1, a content according to an attribute of at least one of the persons detected by the detection unit 233-1, as the content to be displayed on the display device 50.

As an example, the selection unit 237-1 selects a content according to an attribute of a person who has a slower walking speed (moving speed) than at least one other person among the plurality of persons detected by the human detection unit 2331-3. For example, the selection unit 237-1 selects, based on the walking speeds of the persons indicated by the detection result received from the speed detection unit 235-1, a content associated with the attribute of the person whose walking speed is relatively slow among the persons detected by the human detection unit 2331-1. Specifically, the person whose walking speed is relatively slow is the person who has the slowest walking speed among the persons detected by the human detection unit 2331-1.

Here, the selection unit 237-1 may select a person when performing the content selection process. For example, the selection unit 237-1 selects a person as a content selection target from at least one person detected by the detection unit 233-1, based on the detection result received from the detection unit 233-1. Then, the selection unit 237-1 performs a content selection process of selecting a content according to the attribute of the selected person as the content to be displayed on the display device 50.

First, in selecting a person, the selection unit 237-1 selects a person whose walking speed (moving speed) is slower than at least one other person among the plurality of persons detected by the person detection unit 2331-3. For example, the selection unit 237-1 selects a person whose walking speed is relatively slow among the plurality of persons detected by the person detection unit 2331-1, based on the walking speeds of the persons indicated by the detection result received from the speed detection unit 2335-1. The person whose walking speed is relatively slow is, for example, a person whose walking speed is the slowest among the persons detected by the person detection unit 2331-1. Here, the person whose walking speed is relatively slow may be any person as long as that person has a slower walking speed than the person having the fastest walking speed among the plurality of persons. Further, the number of persons selected by the selection unit 237-1 is not limited to one, and may be plural. For example, when the number of persons detected by the human detection unit 2331-1 is four, the selection unit 237-1 selects at least one person other than the person having the fastest walking speed, that is, at least one person from among the person having the slowest walking speed, the person having the second slowest walking speed, and the person having the third slowest walking speed.

Next, in the content selection process, the selection unit 237-1 selects a content according to the attribute of the selected person, as the content to be displayed on the display device 50. For example, the selection unit 237-1 selects a content associated with the attribute of the selected person. When a plurality of persons are selected, the selection unit 237-1 selects, for example, a content associated with the attribute common to each person.

As a result, the selection unit 237-1 can exclude from a content selection target, persons who have a relatively high walking speed and are likely not to see the content displayed on the display device 50.

Therefore, the selection unit 237-1 can select a content suitable for the person who is more likely to see the content.

Here, an example of a relationship between attribute and content is shown.

For example, when gender is detected as an attribute, the selection unit 237-1 selects a content for men, a content for women, or the like, according to the gender.

Further, if age is detected as an attribute, the selection unit 237-1 selects a content for children, a content for adults, or the like, according to the age.

Further, if profession is detected as an attribute, the selection department 237-1 selects a content for office workers, a content for housewives, or the like, according to the profession.

Further, if belongings is detected as an attribute, the selection unit 237-1 selects a content according to the belongings. When a carry bag is detected as an example of the belongings, the selection unit 237-1 selects a content for travelers.

Here, the content selected by the selection unit 237-1 is a content according to an attribute of a person who is approaching the display device 50 among the persons detected by the human detection unit 2331-1 (or the persons selected by the selection unit 237-1). In this case, the selection unit 237-1 selects a person approaching the display device 50 based on the movement direction of the person indicated by the detection result received from the human detection unit 2331-1 (or the person selected by the selection unit 237-1), and selects a content associated with the attribute of the selected person.

As a result, the selection unit 237-1 can exclude from the content selection target, persons who may not see the content, such as persons moving away from the display device 50.

Therefore, the selection unit 237-1 can select a content suitable for the person who is more likely to see the content.

As an example, the selection unit 237-1 select a person who walks relatively slowly and who is approaching the display device 50 among the persons detected by the human detection unit 2331-1 (or the persons selected by the selection unit 237-1), and selects a content associated with an attribute of the selected person.

The content selected by the selection unit 237-1 may be a content according to an attribute of a person who is facing the display device 50 among the persons detected by the human detection unit 2331-1 (or the persons selected by the selection unit 237-1). In this case, the selection unit 237-1 selects a person facing the display device 50, based on the face direction of the person indicated by the detection result received from the direction detection unit 2333-1 (or the person selected by the selection unit 237-1), and selects a content associated with the attribute of the selected person.

As a result, the selection unit 237-1 can exclude from the content selection target, persons who may not see the content, such as persons walking while looking down, persons walking while talking face-to-face with another person, persons walking while operating smartphones, and the like.

Therefore, the selection unit 237-1 can select a content suitable for the person who is more likely to see the content.

As an example, the selection unit 237-1 selects a person who walks relatively slowly and who is facing the display device 50 among the persons detected by the human detection unit 2331-1 (or the persons selected by the selection unit 237-1), and selects a content associated with an attribute of the selected person

The selection unit 237-1 may select a content based on the priority condition. For example, the selection unit 237-1 selects a content based on an attribute (selection condition) according to the priority condition. The priority condition specifies in detail an attribute used to select a content. As a result, the selection unit 237-1 can select a content that matches the characteristics of a person with higher accuracy.

The attributes of persons passing by near the place where the display device 50 is provided may differ depending on the day of the week and the time zone. Therefore, as an example of the priority condition, there is a condition defining a combination of an attribute and at least one of the day of the week and the time zone in which a content is displayed. Based on the priority condition, the selection unit 237-1 selects a content based on the attribute according to the priority condition. As a result, the selection unit 237-1 can select a content for persons according to the day of the week and the time zone and display the content on the display device 50.

As an example of the combination of an attribute and at least one of the day of the week and the time zone, there is a combination of the attribute of “office worker” and the time zone of “commuting.” In this case, the selection unit 237-1 can select a content for office workers and display the content on the display device 50 during the commuting time.

Further, it is desirable that the contents for clerks are not displayed in a store or the like. Therefore, as another example of the priority condition, there is a condition defining an attribute to be excluded from the content selection target. Based on the priority condition, the selection unit 237-1 selects a content based on an attribute of remaining persons excluding the persons indicated by the priority condition. As a result, the selection unit 237-1 can select a content for persons according to the place where the display device 50 is provided and display the content on the display device 50.

For example, in a store, “clerk” is an example of the attribute to be excluded from the content section target. Whether or not the attribute is clerk is determined by, for example, face recognition or image recognition. In image recognition, for example, the clothes of a person, the presence or absence of a name plate, and the like are determined. When clerk is the exclusion target, the selection unit 237-1 excludes a content according to the attribute of clerk from the content selection target. As a result, the selection unit 237-1 can display the contents for customers on the display device 50 in the store.

Here, if no person is detected in the human detection process, or if no person whose movement direction corresponds to the direction of the display device 50 is detected in the direction detection process, the selection unit 237-1 will select a content pre-scheduled.

Here, again, referring to FIG. 1, an example of the person who walks relatively slowly in the first embodiment will be described. Here, it is assumed that a magnitude relationship between the walking speed Vₐ₁ of the pedestrian 2a, the walking speed V_{b1} of the pedestrian 2b, and the walking speed V_{c1} of the pedestrian 2c is V_{c1}>V_{b1}>Vₐ₁. In this case, the person who walks relatively slowly is at least one of the pedestrians other than the pedestrian 2c who has the fastest walking speed. In other words, the two pedestrians, the pedestrian 2a having the slowest walking speed and the pedestrian 2b having the second slowest walking speed, are the persons who walk relatively slowly in the case of FIG. 1.

Here, it is assumed that the attribute used for the content selection is defined based on the selection condition received from the selection condition input unit 210-1. In this case, the selection unit 237-1 selects a content by using the attribute satisfying the selection condition among the attributes of the detected person(s).

### (4) Storage Unit 240-1

The storage unit 240-1 is a storage medium, for example, an HDD (Hard Disk Drive), a flash memory, an EEPROM (Electrically Erasable Programmable Read Only Memory), a RAM (Random Access read/write Memory), a ROM (Read Only Memory), or any combination of these storage media. As the storage unit 240-1, for example, a non-volatile memory can be used.

The storage unit 240-1 stores various information. For example, the storage unit 240-1 stores the selection conditions, the priority conditions, the selection conditions, the attributes of persons, the association information, and the like, which are received from the server device 30. Further, the storage unit 240-1 may store the captured images acquired by the image acquisition unit 231-1.

### <1-3. Functional Configuration of Content Management Device>

The example of the configuration of the content selection device 20-1 according to the first embodiment has been described above. Subsequently, with reference to FIG. 3, an example of a functional configuration of the content management device according to the first embodiment will be described. FIG. 3 is a block diagram showing an example of the functional configuration of the content management device according to the first embodiment. As shown in FIG. 3, the content management device 40 includes a communication unit 410, a content playback unit 420, and a storage unit 430.

### (1) Communication Unit 410

The communication unit 410 transmits and receives various information. For example, the communication unit 410 receives the content selection result from the content selection device 20-1 and outputs the content selection result to the content playback unit 420. Further, the communication unit 410 transmits a video signal of the content received from the content playback unit 420 to the display device 50.

### (2) Content Playback Unit 420

The content playback unit 420 plays back the content to be displayed on the display device 50. For example, the content playback unit 420 plays back the content indicated by the content selection result received from the communication unit 410. The content playback unit 420 plays back the content stored in the storage unit 430. After the playback, the content playback unit 420 outputs to the communication unit 410, the video signal of the content being played back. The process of transmitting the video signal of the content being played back by the content playback unit 420 from the communication unit 410 to the display device 50 and causing the display device 50 to display the content is also referred to as a “content display process” below.

### (3) Storage Unit 430

The storage unit 430 is a storage medium, for example, an HDD (Hard Disk Drive), a flash memory, an EEPROM (Electrically Erasable Programmable Read Only Memory), a RAM (Random Access read/write Memory), a ROM (Read Only Memory), or any combination of these storage media. As the storage unit 430, for example, a non-volatile memory can be used.

The storage unit 430 stores various information. For example, the storage unit 430 stores the contents received from the server device 30.

### <1-4. Processing Flow>

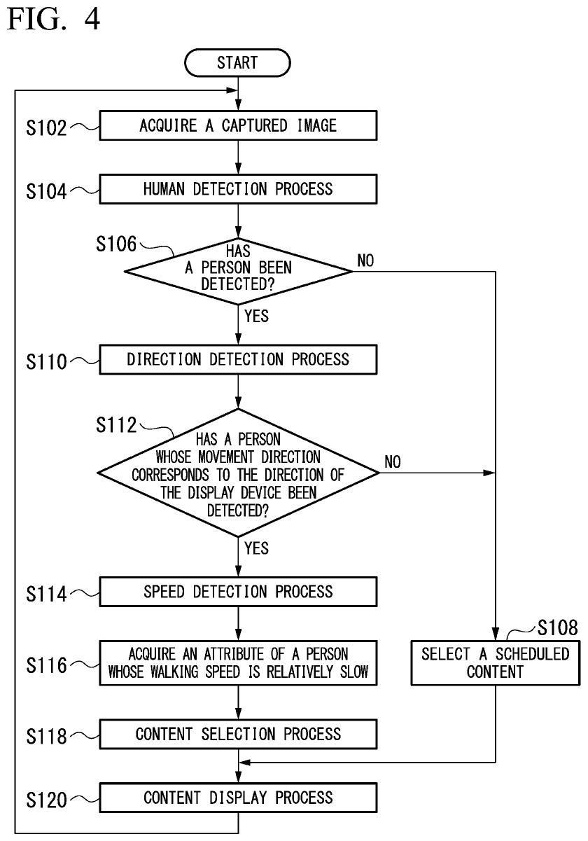

The example of the functional configuration of the content management device 40 according to the first embodiment has been described above. Subsequently, with reference to FIG. 4, an example of a processing flow in the content display system 1 according to the first embodiment will be described. FIG. 4 is a flowchart showing an example of a processing flow in the content display system 1 according to the first embodiment.

As shown in FIG. 4, first, the image acquisition unit 231-1 of the content selection device 20-1 acquires a captured image from the image capture device 10 (S102).

Next, the human detection unit 2331-1 of the content selection device 20-1 performs the human detection process (S104).

After the human detection process, the human detection unit 2331-1 determines whether or not a person has been detected from the captured image (S106).

When no person has been detected from the captured image (S106: NO), the selection unit 237-1 of the content selection device 20-1 selects a pre-scheduled content (S108). After selecting the content, the content selection device 20-1 performs a process at S120 described later.

On the other hand, when a person has been detected from the captured image (S106: YES), the direction detection unit 2333-1 of the content selection device 20-1 performs the direction detection process (S110).

After the direction detection process, the direction detection unit 2333-1 determines whether or not a person whose movement direction corresponds to the direction of the display device 50 has been detected (S112).

When no person whose movement direction corresponds to the direction of the display device 50 has been detected (S112: NO), the selection unit 237-1 selects a pre-scheduled content (S108). After selecting the content, the content selection device 20-1 performs the process at S120 described later.

On the other hand, when a person whose movement direction corresponds to the direction of the display device 50 has been detected (S112: YES), the speed detection unit 2335-1 of the content selection device 20-1 performs the speed detection process (S114).

After the speed detection process, the selection unit 237-1 of the content selection device 20-1 selects a person whose walking speed is relatively slow, and acquires an attribute of the selected person (S116).

After acquiring the attribute, the selection unit 237-1 performs the content selection process based on the acquired attribute (S118).

After the content selection process, the content playback unit 420 of the content management device 40 performs the content display process (S120) and causes the display device 50 to display the content.

After the content display process, the content selection device 20-1 repeats the processing from S102.

As described above, the content selection device 20-1 according to the first embodiment acquires an image captured by the image capture device that images a pedestrian (person). The content selection device 20-1 detects a person included in the captured image. Then, the content selection device 20-1 selects a person who has a slower walking speed (moving speed) than at least one other person from among the plurality of persons detected, and selects a content according to an attribute of the selected person as the content to be displayed on the display device 50

With such a configuration, the content selection device 20-1 according to the first embodiment can select a content suitable for a person who is more likely to see the content among the detected persons.

Therefore, the content selection device 20-1 according to the first embodiment can make the content displayed on the display device 50 easily noticeable to pedestrians.

### 2. Second Embodiment

The first embodiment of the present disclosure has been described above. Subsequently, a second embodiment of the present disclosure will be described. In the first embodiment, an example of selecting a person whose walking speed is relatively slow and selecting a content according to an attribute of the selected person has been described, but the present disclosure is not limited to such an example. In the second embodiment, an example of selecting a person who is relatively close to the display screen 52 of the display device 50 among the persons whose walking speeds are relatively slow and selecting a content according to an attribute of the selected person will be described. Hereinafter, a description overlapping with the description in the first embodiment will be omitted as appropriate.

### <2-1. Configuration of Content Display System>

A configuration of a content display system according to the second embodiment is the same as the configuration of the content display system 1 described with reference to FIG. 1.

### <2-2. Functional Configuration of Content Selection Device>

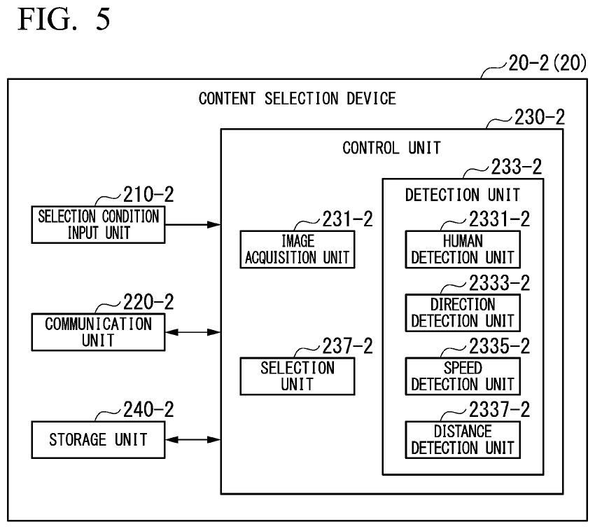

Subsequently, with reference to FIG. 5, an example of a functional configuration of the content selection device according to the second embodiment will be described. FIG. 5 is a block diagram showing an example of the functional configuration of the content selection device according to the second embodiment. As shown in FIG. 5, a content selection device 20-2 includes a selection condition input unit 210-2, a communication unit 220-2, a control unit 230-2, and a storage unit 240-2.

### (1) Selection Condition Input Unit 210-2

A function of the selection condition input unit 210-2 is the same as the function of the selection condition input unit 210-1 according to the first embodiment described with reference to FIG. 2.

### (2) Communication Unit 220-2

A function of the communication unit 220-2 is the same as the function of the communication unit 220-1 according to the first embodiment described with reference to FIG. 2.

### (3) Control Unit 230-2

The control unit 230-2 controls an entire operation of the content selection device 20-2. The control unit 230-2 is realized by causing a CPU (Central Processing Unit) provided as hardware in the content selection device 20-2 to execute a program. As shown in FIG. 5, the control unit 230-2 includes an image acquisition unit 231-2, a detection unit 233-2, and a selection unit 237-2.

### (3-1) Image Acquisition Unit 231-2

A function of the image acquisition unit 231-2 is the same as the function of the image acquisition unit 231-1 according to the first embodiment described with reference to FIG. 2.

### (3-2) Detection Unit 233-2

The detection unit 233-2 performs various detection processes. As shown in FIG. 5, the detection unit 233-2 includes a human detection unit 2331-2, a direction detection unit 2333-2, a speed detection unit 2335-2, and a distance detection unit 2337-2.

### (3-2-1) Human Detection Unit 2331-2

A function of the human detection unit 2331-2 is the same as the function of the human detection unit 2331-1 according to the first embodiment described with reference to FIG. 2.

### (3-2-2) Direction Detection Unit 2333-2

A function of the direction detection unit 2333-2 is the same as the function of the direction detection unit 2333-1 according to the first embodiment described with reference to FIG. 2.

### (3-2-3) Speed Detection Unit 2335-2

A function of the speed detection unit 2335-2 is the same as the function of the speed detection unit 2335-1 according to the first embodiment described with reference to FIG. 2.

### (3-2-4) Distance Detection Unit 2337-2

The distance detection unit 2337-2 detects a distance from a person included in the captured image to the display device 50. For example, the distance detection unit 2337-2 detects the distance from the person detected by the human detection unit 2331-2 to the display device 50 by an image recognition process for the captured image received from the image acquisition unit 231-2. Here, the distance detection unit 2337-2 may detect the distance to the display device 50 from only a person who is facing the direction corresponding to the direction of the display device 50 detected by the direction detection unit 2333-2. The distance detection unit 2337-2 outputs a detection result to the selection unit 237-2.

The process by which the distance detection unit 2337-2 detects the distance from the person included in the captured image to the display device 50 is also referred to as a “distance detection process” below. Here, the distance detection unit 2337-2 may detect a distance from the person included in the captured image to the display screen 52 of the display device 50.

### (3-3) Selection Unit 237-2

The selection unit 237-2 performs a content selection process in the same manner as the selection unit 237-1 according to the first embodiment described with reference to FIG. 2. The selection unit 237-2 further has a function of performing the content selection process based on a result of the detection by the distance detection unit 2337-2.

For example, the content selected by the selection unit 237-2 based on the result of the detection by the distance detection unit 2337-2 is a content according to an attribute of a person who is close to the display device 50 among the persons detected by the human detection unit 2331-2 (or the persons selected by the selection unit 237-2). In this case, the selection unit 237-2 selects a person who is close to the display device 50 based on the distance to the display device 50 from the persons indicated by the detection result received from the distance detection unit 2337-2 (or the persons selected by the selection unit 237-2), and selects a content associated with an attribute of the selected person.

As a result, the selection unit 237-2 can exclude from a content selection target, persons who may not see the content, such as persons who are far from the display device 50.

Therefore, the selection unit 237-2 can select a content suitable for a person who is more likely to see the content.

As an example, the selection unit 237-2 selects a person who walks relatively slowly and who is relatively close to the display device 50 among the persons detected by the human detection unit 2331-2 (or the persons selected by the selection unit 237-2), and selects a content associated with an attribute of the selected person. Here, the person who is relatively close to the display device 50 is specifically the person who is closest to the display device 50 among the persons detected by the human detection unit 2331-2 (or the persons selected by the selection unit 237-2).

Here, the selection unit 237-2 may select a person who is close to the display screen 52, based on the distance to the display screen 52 of the display device 50 from the persons indicated by the detection result received from the distance detection unit 2337-2 (or the persons selected by the selection unit 237-2), and select a content associated with an attribute of the selected person

As an example, the selection unit 237-2 selects a person who walks relatively slow and who is relatively close to the display screen 52 among the persons detected by the human detection unit 2331-2 (or the persons selected by the selection unit 237-2), and selects a content associated with an attribute of the selected person. Here, the person who is relatively close to the display screen 52 is specifically the person who is closest to the display screen 52 among the persons detected by the human detection unit 2331-2 (or the persons selected by the selection unit 237-2).

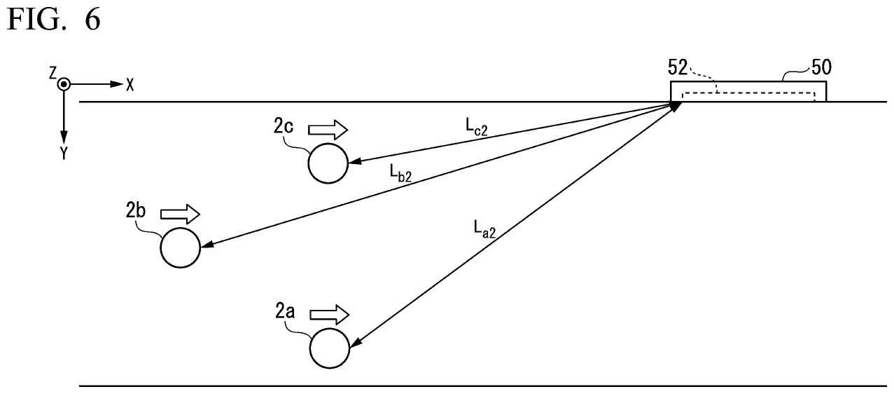

Here, an example of the content selection process in the second embodiment will be described with reference to FIG. 6. FIG. 6 is a diagram showing an example of the content selection process according to the second embodiment. FIG. 6 shows an example in which a content is selected based on a distance from each pedestrian 2 to the display screen 52 of the display device 50. Here, it is assumed that there is a magnitude relationship among a distance Lₐ₂ from the pedestrian 2a to the display screen 52, a distance L_{b2} from the pedestrian 2b to the display screen 52, and a distance L_{c2} from the pedestrian 2c to the display screen 52 is L_{b2}>Lₐ₂>L_{c2}.

In the example shown in FIG. 6, according to the magnitude relationship of the distance Lₐ₂, the distance L_{b2}, and the distance L_{c2}, the pedestrian 2c is located at a position relatively close to the display screen 52 among the pedestrians. Therefore, the selection unit 237-2 selects a content associated with the attribute of the pedestrian 2c located at the position relatively close to the display screen 52.

### (4) Storage Unit 240-2

A function of the storage unit 240-2 is the same as the function of the storage unit 240-1 according to the first embodiment described with reference to FIG. 2.

### <2-3. Functional Configuration of Content Management Device>

A configuration of the content management device according to the second embodiment is the same as the configuration of the content management device 40 described with reference to FIG. 3.

### <2-4. Processing Flow>

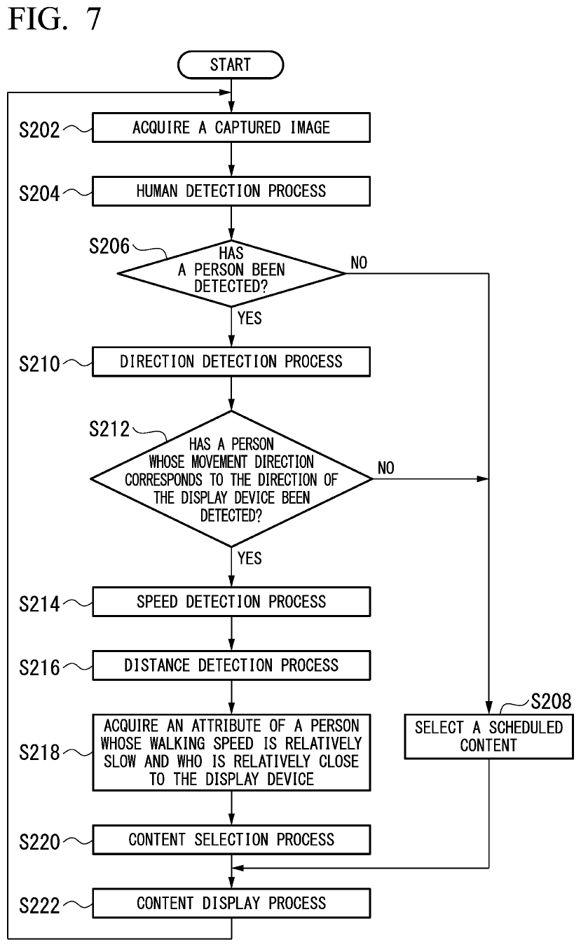

The example of the functional configuration of the content selection device 20-2 according to the second embodiment has been described above. Subsequently, with reference to FIG. 7, an example of a processing flow in the content display system 1 according to the second embodiment will be described. FIG. 7 is a flowchart showing an example of the processing flow in the content display system 1 according to the second embodiment.

As shown in FIG. 7, first, the image acquisition unit 231-2 of the content selection device 20-2 acquires a captured image from the image capture device 10 (S202).

Next, the human detection unit 2331-2 of the content selection device 20-2 performs the human detection process (S204).

After the human detection process, the human detection unit 2331-2 determines whether or not a person has been detected from the captured image (S206).

When no person has been detected from the captured image (S206: NO), the selection unit 237-2 of the content selection device 20-2 selects a pre-scheduled content (S208). After selecting the content, the content selection device 20-2 performs a process at S222 described later.

On the other hand, when a person has been detected from the captured image (S206: YES), the direction detection unit 2333-2 of the content selection device 20-2 performs the direction detection process (S210).

After the direction detection process, the direction detection unit 2333-2 determines whether or not a person whose movement direction corresponds to the direction of the display device 50 has been detected (S212).

When no person whose movement direction corresponds to the direction of the display device 50 has been detected (S212: NO), the selection unit 237-2 selects a pre-scheduled content (S208). After selecting the content, the content selection device 20-2 performs the process at S222 described later.

On the other hand, when a person whose movement direction corresponds to the direction of the display device 50 has been detected (S212: YES), the speed detection unit 2335-2 of the content selection device 20 performs the speed detection process (S214).

After the speed detection process, the distance detection unit 2337-2 of the content selection device 20-2 performs the distance detection process (S216).

After the distance detection process, the selection unit 237-2 of the content selection device 20-2 selects a person whose walking speed is relatively slow and who is relatively close to the display device 50, and acquires an attribute of the selected person (S218).

After acquiring the attribute, the selection unit 237-2 performs the content selection process based on the acquired attribute (S220).

After the content selection process, the content playback unit 420 of the content management device 40 performs the content display process (S222), and causes the display device 50 to display the content.

After the content display process, the content selection device 20-2 repeats the processing from S202.

As described above, the content selection device 20-2 according to the second embodiment acquires an image captured by the image capture device that images a pedestrian (person). The content selection device 20-2 detects a person included in the captured image. Then, the content selection device 20-2 selects a person who has a slower walking speed (moving speed) than at least one other person from among the plurality of persons detected, and selects a content according to an attribute of the selected person as the content to be displayed on the display device 50.

With such a configuration, the content selection device 20-2 according to the second embodiment can select a content suitable for a person who is more likely to see the content among the detected persons.

Further, the content selection device 20-2 according to the second embodiment further has the configuration of detecting a distance to the display device 50 from the person included in the captured image and selecting a content based on the distance.

With such a configuration, the selection unit 237-2 selects a person who is relatively close to the display device 50 among the detected persons, and selects a content according to an attribute of the selected person as the content to be displayed on the display device 50. As a result, the content selection device 20-2 can select a content suitable for a person who is more likely to see the content among the detected persons.

Therefore, the content selection device 20-2 according to the second embodiment can make the content displayed on the display device easily noticeable to pedestrians.

### 3. Third Embodiment

The second embodiment of the present disclosure has been described above. Subsequently, a third embodiment of the present disclosure will be described. In the second embodiment, an example of selecting a person who is relatively close to the display screen 52 of the display device 50 among persons whose walking speed is relatively slow and selecting a content according to an attribute of the selected person has been described, but the present disclosure is not limited to such an example. In the third embodiment, an example of selecting a person who reaches a reference position at the end of the content being played and selecting a content according to an attribute of the selected person will be described. Hereinafter, a description overlapping with the description in the first embodiment and the second embodiment will be omitted as appropriate.

### <3-1. Configuration of Content Display System>

A configuration of a content display system according to the third embodiment is the same as the configuration of the content display system 1 described with reference to FIG. 1.

### <3-2. Functional Configuration of Content Selection Device>

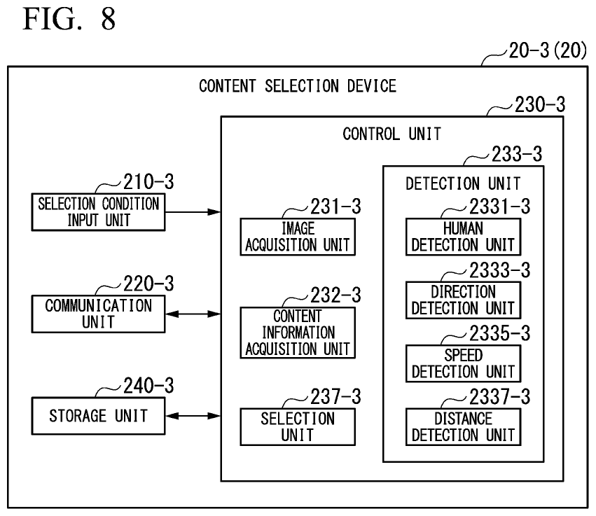

Subsequently, with reference to FIG. 8, an example of a functional configuration of a content selection device according to the third embodiment will be described. FIG. 8 is a block diagram showing an example of the functional configuration of the content selection device according to the third embodiment. As shown in FIG. 8, the content selection device 20-3 includes a selection condition input unit 210-3, a communication unit 220-3, a control unit 230-3, and a storage unit 240-3.

### (1) Selection Condition Input Unit 210-3

A function of the selection condition input unit 210-3 is the same as the function of the selection condition input unit 210-1 according to the first embodiment described with reference to FIG. 2.

### (2) Communication Unit 220-3

A function of the communication unit 220-3 is the same as the function of the communication unit 220-1 according to the first embodiment described with reference to FIG. 2.

### (3) Control Unit 230-3

The control unit 230-3 controls an entire operation of the content selection device 20-3. The control unit 230-3 is realized by causing a CPU (Central Processing Unit) provided as hardware in the content selection device 20-3 to execute a program. As shown in FIG. 8, the control unit 230-3 includes an image acquisition unit 231-3, a content information acquisition unit 232-3, a detection unit 233-3, and a selection unit 237-3.

### (3-1) Image Acquisition Unit 231-3

A function of the image acquisition unit 231-3 is the same as the function of the image acquisition unit 231-1 according to the first embodiment described with reference to FIG. 2.

### (3-2) Content Information Acquisition Unit 232-3

The content information acquisition unit 232-3 acquires information related to contents. For example, the content information acquisition unit 232-3 acquires playback status information indicating a playback status of the content displayed on the display device 50. As an example, the content information acquisition unit 232-3 acquires, as the playback status information, information indicating an elapsed state of the playback time of the content displayed on the display device 50.

The elapsed state of the playback time of the content includes, for example, a content playback time and a content playback start time. Further, the elapsed time of the playback time of the content may include an elapsed time from the playback start of the content or a remaining playback time of the content. The content information acquisition unit 232-3 outputs the acquired playback status information to the selection unit 237-3.

### (3-3) Detection Unit 233-3

The detection unit 233-3 performs various detection processes. As shown in FIG. 8, the detection unit 233-3 includes a human detection unit 2331-3, a direction detection unit 2333-3, a speed detection unit 2335-3, and a distance detection unit 2337-3.

### (3-3-1) Human Detection Unit 2331-2

A function of the human detection unit 2331-3 is the same as that of the human detection unit 2331-1 according to the first embodiment described with reference to FIG. 2.

### (3-3-2) Direction Detection Unit 2333-3

A function of the direction detection unit 2333-3 is the same as the function of the direction detection unit 2333-1 according to the first embodiment described with reference to FIG. 2.

### (3-3-3) Speed Detection Unit 2335-3

The speed detection unit 2335-3 has the same function as that of the speed detection unit 2335-1 according to the first embodiment described with reference to FIG. 2. The speed detection unit 2335-3 further outputs the detection result to the selection unit 237-3.

### (3-3-4) Distance Detection Unit 2337-3

The distance detection unit 2337-3 detects a distance from the detected person to the display device 50 or the display screen 52, similarly to the distance detection unit 2337-2 according to the second embodiment described with reference to FIG. 5. The distance detection unit 2337-3 further has a function of detecting a distance which the person detected in an area captured by the image capture device 10 (hereinafter, also referred to as “image capture area”) moves from the image capture area to the display device 50 or the display screen 52 (hereinafter, also referred to as “movement distance”).

For example, the distance detection unit 2337-3 detects, based on an image recognition process for the captured image, a movement distance from a detected position where a person is detected in the image capture area to the reference position based on the display device 50 or the display screen 52. The distance detection unit 2337-3 outputs the detected movement distance to the selection unit 237-3.

### (3-4) Selection Unit 237-3

The selection unit 237-3 performs the content selection process in the same manner as the selection unit 237-1 according to the first embodiment described with reference to FIG. 2. The selection unit 237-3 further has a function of performing the content selection process based on a result of the detection by the distance detection unit 2337-3.

For example, the content selected by the selection unit 237-3 based on a result of the detection by the distance detection unit 2337-3 is a content to be displayed on the display device 50 after the playback of another content displayed when the selection unit 237-3 selects the content. Further, the selected content is a content according to an attribute of a person who is close to the display device 50 at the end of the playback of the other content displayed on the display device 50, among the persons detected by the human detection unit 2331-3 (or the persons selected by the selection unit 237-3). In this case, based on the movement distance, the playback status information, and the walking speed, the selection unit 237-3 selects from among the detected persons (or the persons selected by the selection unit 237-3), a person who is close to the display device 50 at the end of the playback of the other content displayed on the display device 50, and selects a content associated with the attribute of the selected person

As a result, the selection unit 237-3 can exclude from the content selection target, persons who may not see the content, such as persons who are far from the display device 50.

Therefore, the selection unit 237-3 can select a content suitable for a person who is more likely to see the content.

More specifically, first, the selection unit 237-3 calculates a movement time required for the detected person to reach the reference position based on the walking speed and the movement distance.

Next, the selection unit 237-3 acquires a remaining playback time of the content based on the playback status information. When the playback status information includes the remaining playback time of the content, the selection unit 237-3 acquires the remaining playback time of the content included in the playback status information.

On the other hand, when the playback status information does not include the remaining playback time of the content, the selection unit 237-3 calculates a remaining playback time of the content based on the information included in the playback status information.

For example, the selection unit 237-3 calculates a remaining playback time of the content based on the current time, and the playback time of the content and the playback start time of the content which are included in the playback status information.

Further, the selection unit 237-3 may calculate a remaining playback time of the content based on the playback time of the content and the elapsed time from the playback start of the content, which are included in the playback status information.

The selection unit 237-3 compares the calculated movement time with the acquired remaining playback time of the content, selects a person whose movement time matches the remaining playback time of the content, and selects a content associated with an attribute of the selected person. The person whose movement time matches the remaining playback time of the content is, that is, a person who reaches the reference position at the end of the content being played.

Here, if there is no person who reaches the reference position at the end of the content being played, the selection unit 237-3 selects a pre-scheduled content.

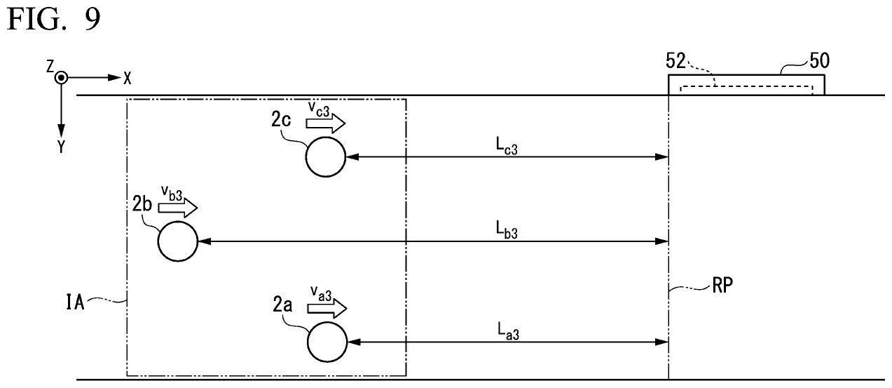

Here, an example of the content selection process in the third embodiment will be described with reference to FIG. 9. FIG. 9 is a diagram showing an example of the content selection process according to the third embodiment. FIG. 9 shows an example in which a content is selected based on a movement time from a position where each pedestrian 2 is detected in an image capture area IA to a reference position RP. Here, the reference position RP shown in FIG. 9 is based on the end of the display device 50 on the negative direction side of the X axis.

First, the selection unit 237-3 calculates a movement time required for each pedestrian 2 to reach the reference position, based on a walking speed and a movement distance of each pedestrian 2. In the case of the example shown in FIG. 9, a moving time Tₐ of the pedestrian 2a is Lₐ₃/Vₐ₃, a moving time T_{b} of the pedestrian 2b is L_{b3}/V_{b3}, and a moving time T_{c} of the pedestrian 2c is L_{c3}/V_{c3}.

Next, the selection unit 237-3 acquires a remaining playback time of the content based on the playback status information. In the example shown in FIG. 9, it is assumed that the remaining playback time of the acquired content is T₀.

Next, the selection unit 237-3 compares the calculated movement time with the acquired remaining playback time of the content, selects a person whose movement time matches the remaining playback time of the content, and selects a content associated with an attribute of the selected person. When the movement time Tₐ of the pedestrian 2a matches the remaining playback time T₀ of the content, the selection unit 237-3 selects the pedestrian 2a, and selects a content associated with the attribute of the pedestrian 2a.

When the movement time T_{b} of the pedestrian 2b matches the remaining playback time T₀ of the content, the selection unit 237-3 selects the pedestrian 2b, and selects a content associated with the attribute of the pedestrian 2b.

When the movement time T_{c} of the pedestrian 2c matches the remaining playback time T₀ of the content, the selection unit 237-3 selects the pedestrian 2c, and selects a content associated with the attribute of the pedestrian 2c.

### (4) Storage Unit 240-3

A function of the storage unit 240-3 is the same as the function of the storage unit 240-1 according to the first embodiment described with reference to FIG. 2.

### <3-3. Functional Configuration of Content Management Device>

A configuration of the content management device according to the third embodiment is the same as the configuration of the content management device 40 described with reference to FIG. 3.

### <3-4. Processing Flow>

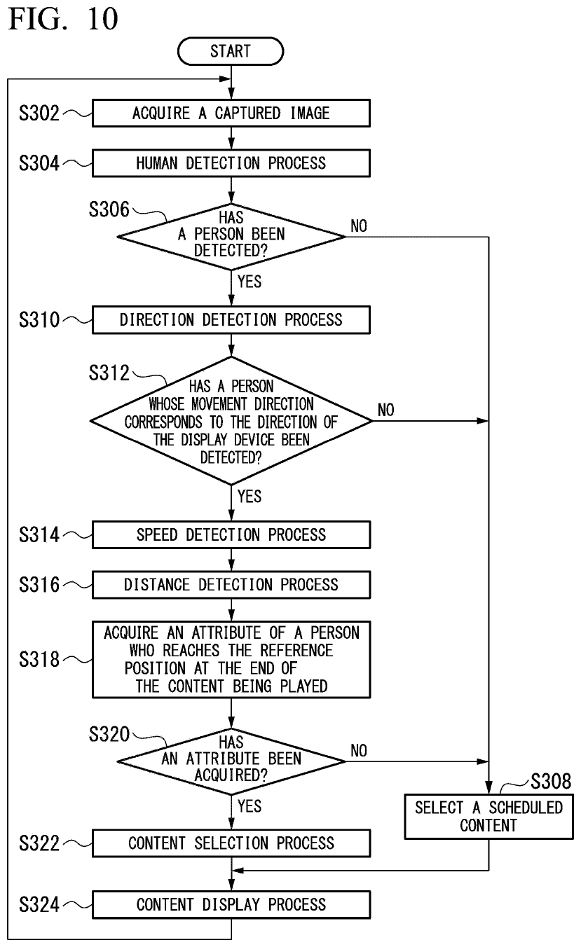

The example of the functional configuration of the content selection device 20-3 according to the third embodiment has been described above. Subsequently, with reference to FIG. 10, an example of a processing flow in the content display system 1 according to the third embodiment will be described. FIG. 10 is a flowchart showing an example of the processing flow in the content display system 1 according to the third embodiment.

As shown in FIG. 10, first, the image acquisition unit 231-3 of the content selection device 20-3 acquires a captured image from the image capture device 10 (S302).

Next, the human detection unit 2331-3 of the content selection device 20-3 performs the human detection process (S304).

After the human detection process, the human detection unit 2331-3 determines whether or not a person has been detected from the captured image (S306).

When no person has been detected from the captured image (S306: NO), the selection unit 237-3 of the content selection device 20-3 selects a pre-scheduled content (S308). After selecting the content, the content selection device 20-3 performs a process at S324 described later.

On the other hand, when a person has been detected from the captured image (S306: YES), the direction detection unit 2333-3 of the content selection device 20-3 performs the direction detection process (S310).

After the direction detection process, the direction detection unit 2333-3 determines whether or not a person whose movement direction corresponds to the direction of the display device 50 has been detected (S312).

When no person whose movement direction corresponds to the direction of the display device 50 has been detected (S312: NO), the selection unit 237-3 selects a pre-scheduled content (S308). After selecting the content, the content selection device 20-3 performs the process at S324 described later.

On the other hand, when a person whose movement direction corresponds to the direction of the display device 50 has been detected (S312: YES), the speed detection unit 2335-3 of the content selection device 20-3 performs the speed detection process (S314).

After the speed detection process, the distance detection unit 2337-3 of the content selection device 20-3 performs the distance detection process (S316).

After the distance detection process, the selection unit 237-3 of the content selection device 20-3 selects a person who reaches the reference position at the end of the content being played, and acquires an attribute of the selected person (S318).

After the attribute acquisition process, the selection unit 237-3 determines whether or not an attribute has been acquired (S320).

If no attribute could be acquired (S320: NO), the selection unit 237-3 selects a pre-scheduled content (S308). After selecting the content, the content selection device 20-3 performs the process at S324 described later.

On the other hand, when an attribute could be acquired (S320: YES), the selection unit 237-3 performs the content selection process based on the acquired attribute (S322).

After the content selection process, the content playback unit 420 of the content management device 40 performs the content display process (S324), and causes the display device 50 to display the content.

After the content display process, the content selection device 20-3 repeats the processing from S302.

As described above, the content selection device 20-3 according to the third embodiment acquires an image captured by the image capture device that images a pedestrian (person). The content selection device 20-3 detects a person included in the captured image. Then, the content selection device 20-3 selects a person who has a slower walking speed (moving speed) than at least one other person from among the plurality of persons detected, and selects a content according to an attribute of the selected person as the content to be displayed on the display device 50

With such a configuration, the content selection device 20-3 according to the third embodiment can select a content suitable for a person who is more likely to see the content among the detected persons.

Therefore, the content selection device 20-3 according to the third embodiment can make the content displayed on the display device 50 easily noticeable to pedestrians.

Further, the content selection device 20-3 according to the third embodiment further has the configuration of, based on the movement distance, the playback status information, and the walking speed, selecting from among the detected persons, a person who reaches the reference position at the end of the content being played, and selecting a content according to an attribute of the selected person.

With such a configuration, when the playback of the currently playing content ends, the selection unit 237-3 can display (play back) on the display device 50, the content selected according to the attribute of the person who reaches the reference position at the end of the currently playing content.

Therefore, the selection unit 237-3 can display (play back) the next content on the display device 50 so that the display (playback) of the currently playing content is not interrupted in the middle.

### 4. Fourth Embodiment

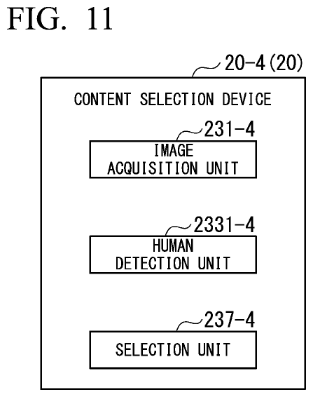

The third embodiment of the present disclosure has been described above. Subsequently, a fourth embodiment of the present disclosure will be described with reference to FIG. 11. FIG. 11 is a block diagram showing an example of a functional configuration of a content selection device according to the fourth embodiment of the present disclosure.

As shown in FIG. 11, a content selection device 20-4 according to the fourth embodiment may include at least an image acquisition unit 231-4, a human detection unit 2331-4, and a selection unit 237-4.

The image acquisition unit 231-4 acquires an image captured by the image capture device that images a pedestrian (person).

The human detection unit 2331-4 detects a person included in the image acquired by the image acquisition unit 231-4.

The selection unit 237-4 selects a person who has a slower walking speed (moving speed) than at least one other person from among the plurality of persons detected, and selects a content according to an attribute of the selected person as the content to be displayed on the display device.

With such a configuration, the content selection device 20-4 according to the fourth embodiment can select a content suitable for a person who is more likely to see the content, among the detected pedestrians.

Therefore, the content selection device 20-4 according to the fourth embodiment can make the content displayed on the display device 50 easily noticeable to pedestrians.

The embodiments of the present disclosure have been described above. It should be noted that a computer may realize all or part of the functions of the content display system 1 in each of the above-described embodiments. In that case, a program for realizing the functions may be recorded on a computer-readable recording medium, so that a computer system reads and executes the program recorded on the recording medium to realize the functions. Here, the term “computer system” as used herein includes hardware such as an OS and peripheral devices. Further, the “computer-readable recording medium” refers to a portable medium such as a flexible disk, a magneto-optical disk, a ROM, or a CD-ROM, and a storage device such as a hard disk built in a computer system. Further, a “computer-readable recording medium” may include one that dynamically holds a program for a short period of time, such as a communication line for transmitting a program via a network such as the Internet or a communication line such as a telephone line; and one that holds a program for a certain period of time, such as a volatile memory inside a computer system that serves as a server or a client in that case. Further, the above program may be one for realizing a part of the above-described functions; one for realizing the above-mentioned functions in combination with a program already recorded in the computer system; or one for realizing the above-mentioned functions by using a programmable logic device such as FPGA (Field Programmable Gate Array).

Although the embodiments of the present disclosure have been described in detail with reference to the drawings, the specific configuration is not limited to the above, and various design changes and the like can be made without departing from the gist of the present disclosure.

1. A content selection device comprising:
an image acquisition unit configured to acquire an image captured by an image capture device configured to capture a person;
a human detection unit configured to detect one or more persons included in the image; and
a selection unit configured to
select a first person who has a slower moving speed than at least one other person from among the one or more persons, and
select a first content according to an attribute of the first person as a content to be displayed on a display device.

2. The content selection device of claim 1, wherein
the first content is according to the attribute of the first person who is approaching the display device among the one or more persons.

3. The content selection device of claim 1, wherein
the first content is according to the attribute of the first person who is close to the display device among the one or more persons.

4. The content selection device of claim 3, wherein:
the first content is to be displayed after an end of a playback of a second content displayed on the display device at time of the selection by the selection unit, and
the first content is according to the attribute of the first person who is close to the display device at the end of the playback of the second content, among the one or more persons.

5. The content selection device of claim 1, wherein
the first content is according to the attribute of the first person who is facing the display device among the one or more persons.

6. The content selection device of claim 1, wherein
the selection unit is configured to, based on a priority condition defining a first attribute for preferentially selecting a content, select the first content according to the first attribute among one or more attributes of the first person.

7. The content selection device of claim 1, wherein
the selection unit is configured to select the first content based on a priority condition defining a combination of an attribute and at least one of a day of the week and a time zone in which the first content is displayed.

8. The content selection device of claim 1, wherein
the selection unit is configured to, based on a priority condition defining a second attribute to be excluded from a content selection target, select the first content according to an attribute of one or more remaining persons excluding one or more persons belonging to the second attribute.

9. The content selection device of claim 1, wherein
the selection unit is configured to select the first content according to the attribute of the first person who has a slowest moving speed among the one or more persons.

10. The content selection device of claim 7, further comprising:
a selection condition input unit configured to specify which of two or more priority conditions is to be used, wherein
the selection unit is configured to select the first content according to the attribute satisfying a selection condition specified by the selection condition input unit.

11. A content selection method comprising:
acquiring an image captured by an image capture device configured to capture a person;
detecting one or more persons included in the image;
selecting a first person who has a slower moving speed than at least one other person from among the one or more persons; and
selecting a first content according to an attribute of the first person as a content to be displayed on a display device.

12. A content selection device comprising:
an image acquisition unit configured to acquire an image captured by an image capture device configured to capture a person;
a human detection unit configured to detect one or more persons included in the image; and
a selection unit configured to select, as a content to be displayed after an end of a playback of a first content displayed on a display device, a second content according to an attribute of a first person who is close to the display device at the end of the playback of the first content, among the one or more persons.
